(19) United States
(12) Patent Application Publication
(10) Pub. No.: US 2021/0254436 A1
(43) Pub. Date: Aug. 19, 2021

(54) OPTIMIZING RESERVOIR SIMULATION RUNTIME AND STORAGE

(71) Applicant: Saudi Arabian Oil Company, Dhahran (SA)

(72) Inventors: Ali A. Al-Turki, Khobar (SA); Majdi A. Baddourah, Dhahran (SA); Osaid F. Hajjar, Dammam (SA); Khalid S. Al-Zamil, Khobar (SA)

(21) Appl. No.: 16/790,262

(22) Filed: Feb. 13, 2020

(51) Int. Cl. E21B 41/00; G06F 30/28

(52) U.S. Cl. CPC E21B 41/0092; G06F 2111/10; G06F 30/28

(57) ABSTRACT

A simulator for updating a geo-mechanical numerical reservoir model in response to changes in a subterranean environment includes receiving stimulation data representing a reservoir stimulation event of a reservoir, the reservoir represented by a structural model. The simulator simulates the reservoir stimulation event using the stimulation data to update the structural model. During execution of a reservoir simulation of the reservoir, the simulator determines that the simulation event of the reservoir is encountered and pause the simulation, receives the updated structural model of the reservoir, reduces a size of time-steps of the simulation, and resumes execution of the reservoir simulation using the updated structural model to generate simulation output data. The simulator stores the simulation output data for downstream applications.

### TECHNICAL FIELD

This disclosure relates to performing simulations of geological formations in a subterranean environment. More specifically, the present disclosure applies to the storage and use of reservoir structural files used in reservoir simulations (for example, for oil wells).

### BACKGROUND

Reservoir structural file definitions can be a key input to reservoir simulations and models. The definitions can define how the reservoirs look, determine the level of detail of information that is stored, and represent a desired discretization for mathematical representation. The structure of reservoir structural files can be based on a function of flow zonation (for example, units), facies distribution, porosity and permeability, rock quality, well density, and fluid flow models. The facies distribution can define, for example, geological characteristics including rock formations, composition, and fossil content. Numerical reservoir simulation can be very resource intensive, requiring high-performance computing capacity and high-performance storage.

### SUMMARY

Generally, numerical geological models are able to capture details of the field operations, especially operations impacting key reservoir rock properties such as permeability and porosity near and further away from the wells. Those processes, namely, stimulation and hydraulic fracturing jobs have a great impact on the fluid flow from the reservoir to the producers or from injectors to the reservoir.

This disclosure describes processes to closely approximate the capabilities of geo-mechanical numerical reservoir simulators with fewer modeling requirements and computationally less expensive numerical simulation options. Conventionally, the geological (static) properties are updated/changed during the numerical reservoir simulation run through property modifiers. However, acid and hydraulic fracturing stimulations are extremely hard, if not impossible, to include in numerical simulator workflows (such as conventional workflows). Additionally, there is an inconsistency between static (geological) and dynamic (numerical) models. Geo-mechanical numerical simulators account for changes to rock properties due to stimulation events. However, not all numerical reservoir simulators allow reservoir geo-mechanics modeling due to the complexity of the mathematical formulation of the problem and the longer simulation runtime. The data processing system subsequently described uses numerical reservoir simulation formation to mimic the reservoir geo-mechanics. The data processing system can simulate stimulation events without the excessive cost of geo-mechanical numerical simulators with high accuracy.

The data processing system provides one or more of the following advantages.

Generally, regarding computation cost, an approximate performance cost decrease as a percentage of the conventional cost can be achieved. For example, live updates to key geological features controlling fluid flow in the geological environment can be performed while the simulation model is running to accurately mimic the impact on productivity/injectivity without additional computation cost.

The data processing system is configured to provide real time updates to geological features controlling fluid flow in the simulation while the simulation model is running to accurately mimic the impact on productivity, injectivity, or both. The data processing system provides a more realistic reflection of the impact of hydraulic fracturing on geology. Generally, conventional numerical reservoir simulation precision degrades when modeling impact of hydraulic fracturing on reservoir geological characteristics. In contrast, the reservoir model described herein is able to capture historical events and dynamic field operations are without being degraded. For example, using the model for prediction scenarios, forecasting and/or recovery assessment is not negatively impacted as it would be for conventional models. Generally, this reservoir simulation model accurately reflects the impact of hydraulic fracturing on field performance, and therefore avoids degradation in the simulation model accuracy that occurs in existing simulation models. The data processing system provides up-to-date reservoir model geology that can be used for geological modeling to reflect on the reservoir(s) geology and geological workflows.

The systems and methods can include one or more of the following embodiments. In an aspect, a computer-implemented method for updating a geo-mechanical numerical reservoir model in response to changes in a subterranean environment includes the actions of receiving stimulation data representing a reservoir stimulation event of a reservoir. The reservoir is represented by a structural model. The actions include simulating the reservoir stimulation event using the stimulation data to update the structural model. The actions include, during execution of a reservoir simulation of the reservoir, determining that the stimulation event of the reservoir is encountered and pause the simulation; receiving the updated structural model of the reservoir; reducing a size of time-steps of the simulation; and resuming execution of the reservoir simulation using the updated structural model to generate simulation output data. The actions include storing the simulation output data.

In some implementations, the reservoir stimulation event includes at least one of an acidizing stimulation event of the reservoir and an hydraulic fracturing stimulation event of the reservoir. In some implementations, simulating the reservoir stimulation event comprises a numerical reservoir simulation compatible with the reservoir simulation of the reservoir.

In some implementations, the simulation output data includes rock properties data and fluid properties data. Storing the simulation output data comprises sending the rock properties data and the fluid properties data to an asset repository to synchronize the structural model with a dynamic model of the reservoir.

In some implementations, the stimulation data comprise fracture flow properties of the reservoir, permeability of the reservoir, stress-permeability relationship data of the reservoir, fracture properties of the reservoir, and rates definitions for the reservoir.

In some implementations, the actions include updating, using the simulation output data, a digital model of the reservoir, the digital model including a geomechanical numerical model.

In an aspect, a system for updating a geo-mechanical numerical reservoir model in response to changes in a subterranean environment includes at least one computing device configured to execute one or more instructions and a memory device storing the one or more instructions, that when executed by the at least one computing device, cause the at least one computing device to perform operations including: receiving stimulation data representing a reservoir stimulation event of a reservoir, the reservoir represented by a structural model. The operations include simulating the reservoir stimulation event using the stimulation data to update the structural model. The operations include, during execution of a reservoir simulation of the reservoir: determining that the stimulation event of the reservoir is encountered and pause the simulation; receiving the updated structural model of the reservoir; reducing a size of time-steps of the simulation; and resuming execution of the reservoir simulation using the updated structural model to generate simulation output data. The operations include storing the simulation output data.

In some implementations, the reservoir stimulation event includes at least one of an acidizing stimulation event of the reservoir and an hydraulic fracturing stimulation event of the reservoir. In some implementations, simulating the reservoir stimulation event comprises a numerical reservoir simulation compatible with the reservoir simulation of the reservoir.

In some implementations, the simulation output data includes rock properties data and fluid properties data. Storing the simulation output data comprises sending the rock properties data and the fluid properties data to an asset repository to synchronize the structural model with a dynamic model of the reservoir.

In some implementations, the stimulation data comprise fracture flow properties of the reservoir, permeability of the reservoir, stress-permeability relationship data of the reservoir, fracture properties of the reservoir, and rates definitions for the reservoir.

In some implementations, the operations include updating, using the simulation output data, a digital model of the reservoir, the digital model including a geomechanical numerical model.

In an aspect, one or more non-transitory computer readable media are storing instructions that are executable by one or more processors configured to perform operations for updating a geo-mechanical numerical reservoir model in response to changes in a subterranean environment. The operations include receiving stimulation data representing a reservoir stimulation event of a reservoir. The reservoir is represented by a structural model. The operations include simulating the reservoir stimulation event using the stimulation data to update the structural model. The operations include, during execution of a reservoir simulation of the reservoir, determining that the stimulation event of the reservoir is encountered and pause the simulation; receiving the updated structural model of the reservoir; reducing a size of time-steps of the simulation; and resuming execution of the reservoir simulation using the updated structural model to generate simulation output data. The operations include storing the simulation output data.

In some implementations, the reservoir stimulation event includes at least one of an acidizing stimulation event of the reservoir and an hydraulic fracturing stimulation event of the reservoir. In some implementations, simulating the reservoir stimulation event comprises a numerical reservoir simulation compatible with the reservoir simulation of the reservoir.

In some implementations, the simulation output data includes rock properties data and fluid properties data. Storing the simulation output data comprises sending the rock properties data and the fluid properties data to an asset repository to synchronize the structural model with a dynamic model of the reservoir.

In some implementations, the stimulation data comprise fracture flow properties of the reservoir, permeability of the reservoir, stress-permeability relationship data of the reservoir, fracture properties of the reservoir, and rates definitions for the reservoir.

In some implementations, the operations include updating, using the simulation output data, a digital model of the reservoir, the digital model including a geomechanical numerical model.

The details of one or more embodiments are set forth in the accompanying drawings and the description below. Other features and advantages will be apparent from the description and drawings, and from the claims.

### BRIEF DESCRIPTION OF THE DRAWINGS

FIGS. 1A and 1B show examples of stimulation events of geological reservoirs.

FIGS. 2A, 2B, and 2C each include a graph that illustrates impacts of hydraulic stimulation on parameters associated with the geological simulation.

FIGS. 3A, 3B, and 3C each include a flow diagram illustrating a process for optimizing reservoir simulation runtime and storage.

FIG. 4 is a diagram of an example computing system.

Like reference numbers and designations in the various drawings indicate like elements.

### DETAILED DESCRIPTION

The following detailed description describes techniques for optimizing reservoir simulation runtime and storage by hashing reservoir model structural and initialization data. Generally, grid data, including reservoir model structural data, can be stored in different formats. The formats can include, for example, cell-centered, corner-point geometry, or an unstructured format, such as perpendicular bisector (PEBI) gridding or its variations. Depending on a size of a model, the reservoir model structural data can usually be large enough to consume a considerable digital footprint, such as by consuming gigabytes of the finite high-performance disk storage. Significant processing time can also occur in the reservoir simulator at model setup and initialization. The reservoir model structure definition (for example, discretization) can remain unchanged after being generated once, as compared to the many times reservoir model structure definition is used for running simulations.

Generally, a process performed by a data processing system for generating and storing simulation model structural information for modeling a reservoir of an oil well can include the following operations. The data processing system initiates a reservoir simulation study. For example, a simulation can be started for a reservoir associated with an oil drilling operation. Once the simulation has started, the data processing system generates reservoir structural data. As an example, during execution of the reservoir simulation study, data for a cell (or other data point) in the reservoir structural data are generated based on information in the reservoir at a particular location. The data processing system outputs the reservoir structural data to a database. For example, the data for the cell can be output to a high-performance file system. The data processing system generates the localized physical location of the reservoir structure files. Generally, a localized physical location of the data can be used without regard to optimization, such as optimization subsequently described. The data processing system generates and initializes a hard link to the structural data. As an example, the data processing system generates a hard link to the newly generated physical location. The data processing system can continue the reservoir simulation study, for example, until the reservoir simulation study ends upon completion of the simulation (for example, of the oil drilling operation).

Generally, the simulation model incorporates all field data: geology, fluids' contacts, events, production, injection . . . etc. This workflow does not account for the geo-mechanical changes/updates except when a geo-mechanical reservoir simulator is used. In such case, the geo-mechanical features of reservoir rocks are modeled.

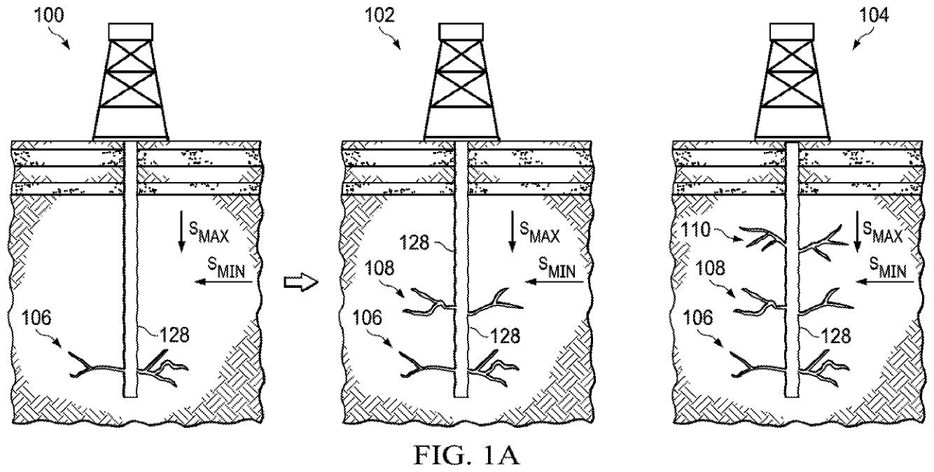

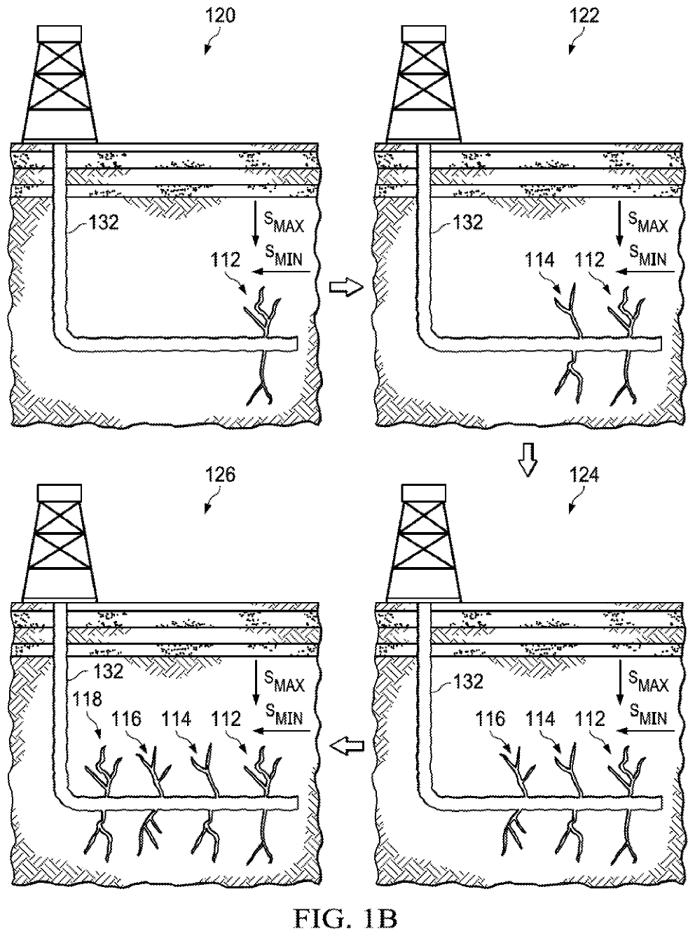

However, during the lifespan of a field, the reservoir that the data processing system is configured to simulate can undergo natural or induced changes on geology of the reservoir. For example, the changes to the geology of the reservoir can span from around the wells (producers/injectors) to areas distant from the wells. FIGS. 1A and 1B show examples of stimulation events of geological reservoirs.

Turning to FIG. 1A, a vertical multi-stage hydraulic fracturing event process is shown. At stage 100, a first fracturing event 106 causes cracks around the well 128. In this example, the fracturing event 106 provides cracks in the surrounding rock to allow fluid to escape from the geological environment to the well 128. As the geological environment has changed around the well 128, the well is remodeled by the data processing system. The remodeling takes the changes of parameters of the geological environment caused by the fracturing event into account for the simulation. For example, rather than assuming a change in the porosity of the geological environment around the well 128, an updated porosity value is modeled by the data processing system.

At stage 102, a second fracturing event 108 occurs, and the data processing system again remodels the geological environment. The second fracturing event 108 generally can occur days, weeks, or months after the first fracturing event 106. Similarly, at stage 104, a third fracturing event 110 occurs, and the data processing system remodels the geological environment. The changes by fracturing events 106, 108, and 110 are generally necessary for enhancing the reservoir connectivity and conductivity. In some implementations, other stimulation processes can be used to update the geological environment. For example, acid stimulation can be used for cleaning the damage around the well 128.

Turning to FIG. 1B, a horizontal multi-stage hydraulic fracturing event process is shown. Similar to the process shown in FIG. 1A, at stage 120, a first fracturing event 112 causes cracks around the well 132. In this example, the fracturing event 120 provides cracks in the surrounding rock to allow fluid to escape from the geological environment to the well 132. As the geological environment has changed around the well 132, the well is remodeled by the data processing system. The remodeling takes the changes of parameters of the geological environment caused by the fracturing event into account for the simulation. For example, rather than assuming a change in the porosity of the geological environment around the well 132, an updated porosity value is modeled by the data processing system.

At stage 122, a second fracturing event 114 occurs, and the data processing system again remodels the geological environment. The second fracturing event 114 generally can occur days, weeks, or months after the first fracturing event 112. Similarly, at stage 124, a third fracturing event 116 occurs, and the data processing system remodels the geological environment. Finally, at stage 126, a fourth fracturing event 118 occurs, and the data processing system remodels the geological environment. At each of stages 120, 122, 124, and 126, the data processing system remodels the geological environment to account not only for the most recent fracturing event, but all prior fracturing events.

As stated previously, other stimulation processes can be used to update the geological environment around well 132. For example, acid stimulation can be used for cleaning the damage around the well 132. Regardless of the type of stimulation event performed, the well stimulation introduces changes to geology that did not exist originally. For example, in the case of acid stimulation, the wellbore skin is adjusted to reflect the flow at sand-face to the well. Generally, the penetration of the acid is localized around the wellbore area 128 or 132. As a result, changes to flow-controlling geological features is negligible. On the contrary, in the case of hydraulic fracturing stimulation, the changes to permeability and porosity around and farther away from the wells 128 and 132 have substantial impact on productivity and injectivity of the wells.

To reflect those changes on the simulation model, the well productivity index (PI) can be adjusted to reflect the impact of the hydraulic fracturing event. However, there are two shortcomings of this practice: the geological model is not valid any more, and the relationship between the reservoir simulation model and a corresponding geological model is lost, and the two models are inconsistent. The data processing system instead is configured to perform real-time updates on the geological model (including at least one of permeability and porosity) to reflect the induced changes by hydraulic fracturing events, such as those of FIGS. 1A-1B. The data processing system performs updates to the geological model and is also configured to respond to the inputs by an operator while executing the simulation.

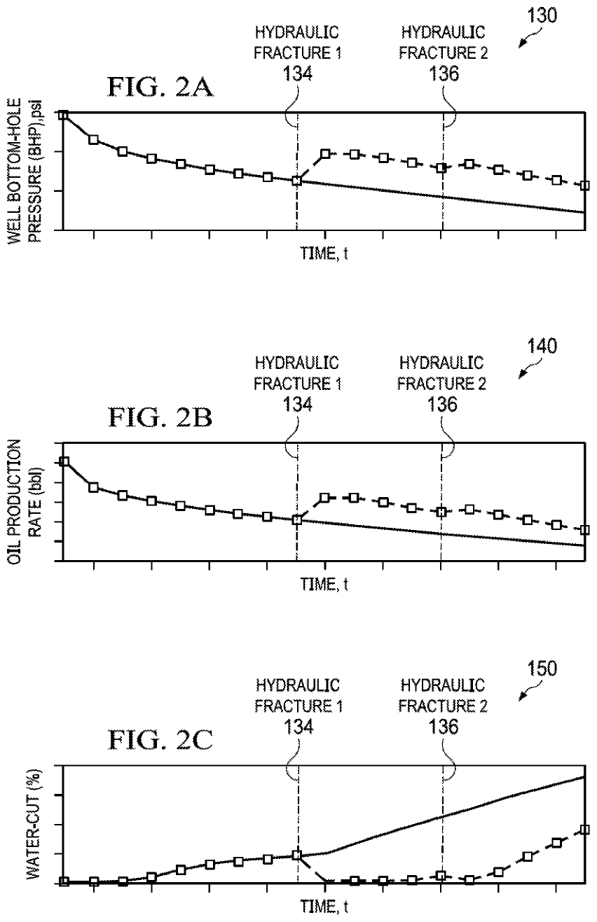

Turning to FIGS. 2A-2C, graphs 130, 140, and 150 illustrate impacts of hydraulic stimulation on parameters associated with the geological simulation. The hydraulic stimulation can include the fracturing events illustrated in FIGS. 1A-1B. In graph 130 of FIG. 2A, a relationship between well bottom-hole pressure (BHP) and time is shown. BHP is measured in pounds-per-square-inch (psi). As shown in graph 130, well bottom-hole pressure steadily decreases over time until a fracturing event 134 (such as event 106 of FIG. 1A or event 112 of FIG. 1B) are introduced. The BHP immediately increases as the geological environment has changed substantially. The data processing system is configured to remodel the geological environment for the simulation after the first fracturing event. As the BHP again steadily decreases, a second fracturing event 136 is introduced (such as event 108 of FIG. 1A or event 114 of FIG. 1B). Again, the BHP increases, but not quite as much as in response to the first fracturing event 134. The data processing system remodels the geological model taking into account each of the prior fracturing events, and thus remodels a diminished increase in BHP in response to subsequent fracturing events.

Turning to FIG. 2B, graph 140 illustrates an impact of hydraulic stimulation of a well on oil production rate in barrels (bbl) over time t. Similar to graph 130 of FIG. 2A, the oil production rate steadily decreases over time until the fracturing event 134 is introduced. The oil production rate immediately increases as the geological environment has changed substantially (for example, the BHP is increased). The data processing system is configured to remodel the geological environment for the simulation after the first fracturing event. As the oil production rate again steadily decreases, the second fracturing event 136 is introduced. Again, the oil production rate increases, but not quite as much as in response to the first fracturing event 134. The data processing system remodels the geological model taking into account each of the prior fracturing events, and thus remodels a diminished increase in oil production rate in response to subsequent fracturing events.

Turning to FIG. 2C, graph 150 illustrates an impact of hydraulic stimulation of a well on water production rate as a percentage of well output over time t. In contrast to the oil production rate shown in graph 140 of FIG. 2B, the water production rate steadily increases over time until the fracturing event 134 is introduced. The water production rate immediately decreases as the geological environment has changed substantially (for example, the BHP is increased). The data processing system is configured to remodel the geological environment for the simulation after the first fracturing event. As the water production rate again steadily decreases, the second fracturing event 136 is introduced. Again, the water production rate decreases, but not quite as much as in response to the first fracturing event 134. The data processing system remodels the geological model taking into account each of the prior fracturing events, and thus remodels a diminished decrease in water production rate in response to subsequent fracturing events.

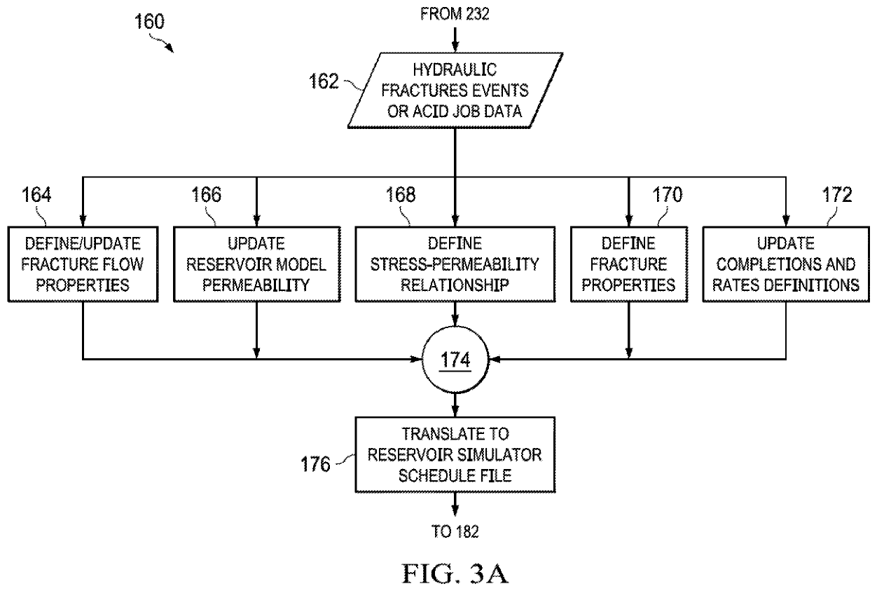

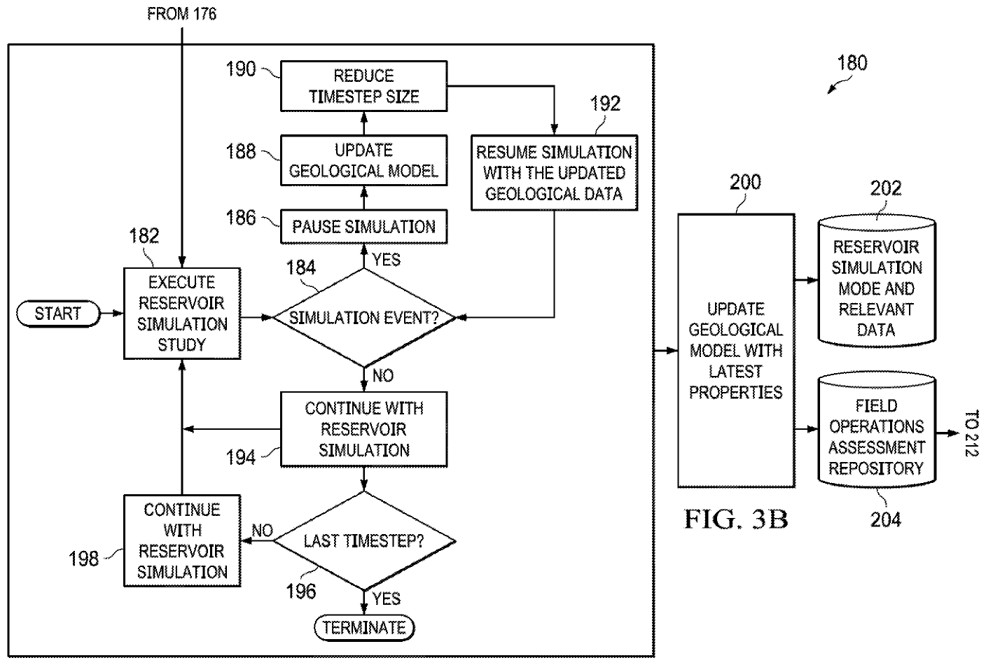

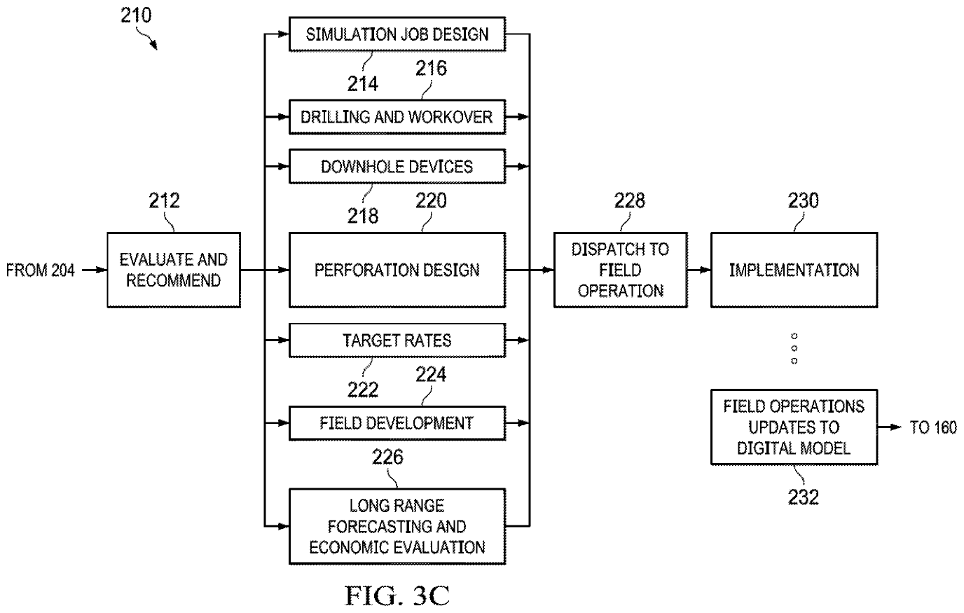

Turning to FIGS. 3A-3C, processes for optimizing reservoir simulation runtime and storage is shown. The data processing system that executes the processes of FIGS. 3A-3C is configured to update a numerical reservoir simulator to account for reservoir rock changes described previously. The data processing system includes hydraulic fracturing events (or other stimulation events) in a simulator schedule file as an input to be processed during a simulation of the geological environment.

Turning to FIG. 3A, a flow diagram is shown representing a process 160 for gathering stimulation data by the data processing system. Generally, a number of data types are provided to the data processing system to model and characterize fluid flow and induced changes to the reservoir rocks. The data processing system is configured to receive (162) stimulation data including hydraulic fractures events or acid job data. The stimulation data can include any data describing a stimulation event. The stimulation data can include fracture flow properties data, such as pressure-volume-temperature (PVT) properties and relative permeability of fluid flow the geological environment. The stimulation data can include reservoir permeability data ascertained from pore geometry, wettability, fluid distribution, and fluid saturation history. The stimulation data can include stress-permeability relationship data, which may be affected by fracture shear offset and fracture infilling by mineral precipitation. The stimulation data can include fracture properties data. The stimulation data can include completions and rates data after hydraulic fracturing is performed. Generally, historical events are pre-modeled and are not altered. However, future field development events are updated based on the business and operational requirements of the user, and various scenarios can be used to predict events data.

The data processing system is configured to update parameters of the simulation based on this data that are received. For example, the data processing system defines/updates (164) the fracture flow properties of the geological environment. The data processing system updates (166) the reservoir model permeability value. The data processing system defines (168) the stress-permeability relationship of the well. The data processing system defines (170) the fracture properties of the fracture events. The data processing system updates (172) the completions and rates definitions post fracturing. The data processing system combines (174) these data into a report that is translated (176) into a reservoir simulator schedule file for sending to the ongoing simulation study. For example, each of the hydraulic fracturing job reports described above are translated to and modeled in the language of the reservoir simulator. Generally, these job reports generated in advance of the simulation study. The reports are pre-generated in the case of historical events. For predictions of future events, the reports are proposed as a scenario to be assessed by numerical reservoir simulation.

Turning to FIG. 3B, a block diagram showing a process 180 for numerical simulation by the data processing system using the updated data from the stimulation event. Once the data processing system translates the data from the stimulation events to a schedule file for the numerical simulator, the data processing system executes (182) numerical simulation. The data processing system continues execution of the simulation until detecting (184) a fracturing event (or series of events) is encountered at which the simulation is paused (186). Generally, if stimulation are being received, the data processing system has already been executing the numerical simulation of the geological environment in a pre-stimulation configuration.

Before the data processing system resumes the simulation, the data processing system performs several actions. The data processing system updates (188) the geological model with the data from the schedule file received from process 160 of FIG. 3A. The data processing system reduces (190) a time-step size of the simulation. The time-step size is generally reduced to a minimal size. This occurs to avoid numerical convergence issues and time-step cuts that may occur with larger time-step sizes. In other words, the time resolution of the simulation is temporarily increased to a maximum amount to ensure that the fracturing event (or other stimulation event) is modeled as accurately as possible.

Once the data processing system reduces the time-step of the simulation, the data processing system resumes (192) numerical simulation from the point where the simulation was paused. The number of time-steps after a stimulation event occurs that the time-step reduction persists can vary. Generally, the data processing system begins with a small time-step size, gradually increasing it until the original time-step is reached. This generally occurs within few days of the simulation event. The time-step size is subject to the convergence of the numerical solver (simulator). This is to overcome the effect of abrupt pressure and saturation changes in the fracture(s). The data processing system repeats 186, 188, 190, and 192 each time a hydraulic fracturing event is encountered in the simulation schedule file. Otherwise, the simulation continues (194) without any interruptions until determining (196) that the last date card in the simulation model is reached. If additional time-steps are yet to be simulated, the data processing system continues (198) with the simulation.

The data processing system updates (200) the geological model once the simulation is completed. The data processing system updates the original geological model with the latest updates to rock and fluid properties and then pushed to an asset repository, such as storing (204) the data in the field operations assessment repository. In some implementations, the data processing system stores (202) other data about the simulation in a reservoir simulation mode repository. Generally, different copies of updates to the geological model are stored for different fracture events. The fracture or stimulation jobs are performed at different in times throughout the lifespan of the field.

The data processing system has synchronized dynamic and static geological models. The data processing system is ready utilize each of these models for predictions and forecasting as well as for enabling near-real time updates to the geologic model over an extended period of time (e.g., months or years). Additionally, the geological model closely represents the actual physical assets of the environment being modeled (e.g., simulated assets are modeled within a threshold accuracy of the assets themselves). As previously stated, the updated geological models are stored in the field operations assessment repository and are accessible during subsequent modeling.

Turning to FIG. 3C, a block diagram illustrating a process 210 for application of the updated model generated by the data processing system during process 180 of FIG. 3B. Generally, the data processing system retrieves (212) data from the field operations assessment repository during evaluation and recommendation processes. The evaluation and recommendation processes can include any recommendations relating to operation of the well that is simulated. For example, the data processing system uses the evaluations and recommendations developed from the updated geological model to guide decisions to trigger (214) a stimulation job study, recommend (216) drilling and workover activities, recommend (218) downhole devices and well completion design processes, perform (22) perforation design, determine (222) target rates for production or injection, perform (224) field development assessments, and perform (226) long range forecasting and economic evaluation assessments. The data processing system dispatches (228) final recommendations to operations for implementation (230) in the physical geological environment.

In some implementations, the data processing system receives data representing updates to field operations. The data processing system updates (232), using data from field operations, a digital model, such as a numerical reservoir model, by newly collected information from the field such as fracturing, drilling, formation tops, flow tests, or any other data measured from the field. This results in a close digital representation of physical assets. For example, reservoir models are updated to reflect or mirror the physical assets (actual fields/reservoirs). Changes in the geological environment are reflected by the digital model and vice versa.

Generally, the processes of FIGS. 3A-3C represent an approximation of the geo-mechanical reservoir simulators. The data processing system is configured to provide updates to the numerical simulator code without changing the formulation, resulting in a process that is much cheaper to perform and use by the data processing system. In addition, the increase in fracture porosity is compensated for by reducing the rock (matrix) porosity. This is to maintain initial volumes unchanged. Generally, because this trade-off is always true, assuming that initial volumes are unchanged does not affect the accuracy of the simulation. In contrast, this assumption is required to maintain the same reservoir fluid volumes and maintain material balance.

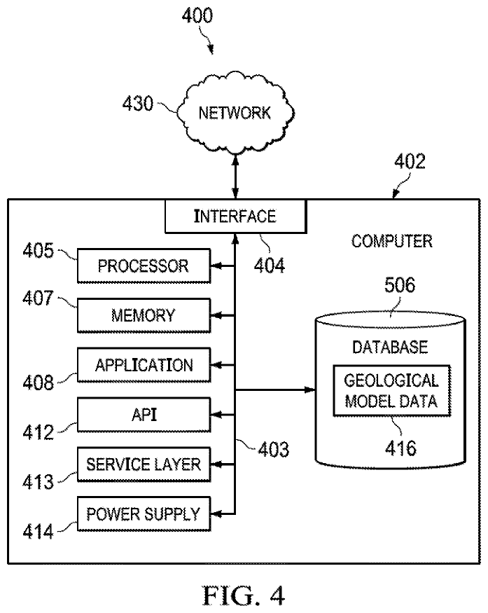

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both), over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the hardware of the interface can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data (for example, geological model data 416) for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user-or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

A number of embodiments have been described. Nevertheless, it will be understood that various modifications may be made without departing from the spirit and scope of the data processing system described herein. Accordingly, other embodiments are within the scope of the following claims.

What is claimed is:

1. A computer-implemented method for updating a geo-mechanical numerical reservoir model in response to changes in a subterranean environment, comprising:
receiving stimulation data representing a reservoir stimulation event of a reservoir, the reservoir represented by a structural model;
simulating the reservoir stimulation event using the stimulation data to update the structural model;
during execution of a reservoir simulation of the reservoir:
determining that the stimulation event of the reservoir is encountered and pause the simulation;
receiving the updated structural model of the reservoir;
reducing a size of time-steps of the simulation; and
resuming execution of the reservoir simulation using the updated structural model to generate simulation output data; and
storing the simulation output data.

2. The computer-implemented method of claim 1, wherein the reservoir stimulation event comprises at least one of an acidizing stimulation event of the reservoir and an hydraulic fracturing stimulation event of the reservoir.

3. The computer-implemented method of claim 1, wherein simulating the reservoir stimulation event comprises a numerical reservoir simulation compatible with the reservoir simulation of the reservoir.

4. The computer-implemented method of claim 1, wherein the simulation output data comprises rock properties data and fluid properties data.

5. The computer-implemented method of claim 4, wherein storing the simulation output data comprises sending the rock properties data and the fluid properties data to an asset repository to synchronize the structural model with a dynamic model of the reservoir.

6. The computer-implemented method of claim 1, wherein the stimulation data comprise fracture flow properties of the reservoir, permeability of the reservoir, stress-permeability relationship data of the reservoir, fracture properties of the reservoir, and rates definitions for the reservoir.

7. The computer-implemented method of claim 1, further comprising updating, using the simulation output data, a digital model of the reservoir, the digital model comprising a geomechanical numerical model.

8. A system for updating a geo-mechanical numerical reservoir model in response to changes in a subterranean environment, comprising:
at least one computing device configured to execute one or more instructions; and
a memory device storing the one or more instructions, that when executed by the at least one computing device, cause the at least one computing device to perform operations comprising:
receiving stimulation data representing a reservoir stimulation event of a reservoir, the reservoir represented by a structural model;
simulating the reservoir stimulation event using the stimulation data to update the structural model;
during execution of a reservoir simulation of the reservoir:
determining that the stimulation event of the reservoir is encountered and pause the simulation;
receiving the updated structural model of the reservoir;
reducing a size of time-steps of the simulation; and
resuming execution of the reservoir simulation using the updated structural model to generate simulation output data; and
storing the simulation output data.

9. The system of claim 8, wherein the reservoir stimulation event comprises at least one of an acidizing stimulation event of the reservoir and an hydraulic fracturing stimulation event of the reservoir.

10. The system of claim 8, wherein simulating the reservoir stimulation event comprises a numerical reservoir simulation compatible with the reservoir simulation of the reservoir.

11. The system of claim 8, wherein the simulation output data comprises rock properties data and fluid properties data.

12. The system of claim 11, wherein storing the simulation output data comprises sending the rock properties data and the fluid properties data to an asset repository to synchronize the structural model with a dynamic model of the reservoir.

13. The system of claim 8, wherein the stimulation data comprise fracture flow properties of the reservoir, permeability of the reservoir, stress-permeability relationship data of the reservoir, fracture properties of the reservoir, and rates definitions for the reservoir.

14. The system of claim 8, further comprising updating, using the simulation output data, a digital model of the reservoir, the digital model comprising a geomechanical numerical model.

15. One or more non-transitory computer readable media storing instructions that are executable by one or more processors configured to perform operations for updating a geo-mechanical numerical reservoir model in response to changes in a subterranean environment, the operations comprising:
receiving stimulation data representing a reservoir stimulation event of a reservoir, the reservoir represented by a structural model;
simulating the reservoir stimulation event using the stimulation data to update the structural model;
during execution of a reservoir simulation of the reservoir:
determining that the stimulation event of the reservoir is encountered and pause the simulation;
receiving the updated structural model of the reservoir;
reducing a size of time-steps of the simulation; and
resuming execution of the reservoir simulation using the updated structural model to generate simulation output data; and
storing the simulation output data.

16. The one or more non-transitory computer readable media of claim 15, wherein the reservoir stimulation event comprises at least one of an acidizing stimulation event of the reservoir and an hydraulic fracturing stimulation event of the reservoir.

17. The one or more non-transitory computer readable media of claim 15, wherein simulating the reservoir stimulation event comprises a numerical reservoir simulation compatible with the reservoir simulation of the reservoir.

18. The one or more non-transitory computer readable media of claim 15, wherein the simulation output data comprises rock properties data and fluid properties data.

19. The one or more non-transitory computer readable media of claim 18, wherein storing the simulation output data comprises sending the rock properties data and the fluid properties data to an asset repository to synchronize the structural model with a dynamic model of the reservoir.

20. The one or more non-transitory computer readable media of claim 15, wherein the stimulation data comprise fracture flow properties of the reservoir, permeability of the reservoir, stress-permeability relationship data of the reservoir, fracture properties of the reservoir, and rates definitions for the reservoir.
